(19) United States
(12) Patent Application Publication
(10) Pub. No.: US 2022/0012678 A1
(43) Pub. Date: Jan. 13, 2022

(54) SYSTEM AND METHOD FOR TRACKING AND TRACING

(71) Applicant: Good Talent Creation Limited, Tsuen Wan (HK)

(72) Inventors: Hoi Kit Leo Cheung, Tsuen Wan (HK); Man Ling Chan, Tsuen Wan (HK); Chee Yan Fu, Foster City, CA (US); Kwok Shing Lai, Tsuen Wan (HK)

(21) Appl. No.: 17/355,065

(22) Filed: Jun. 22, 2021

Related U.S. Application Data
(60) Provisional application No. 62/705,737, filed on Jul. 13, 2020.

(51) Int. Cl. G06Q 10/08; G06K 7/10; G06K 7/14; G06F 16/955

(52) U.S. Cl. CPC G06Q 10/087; G06F 16/9554; G06K 7/1417; G06K 7/10386

(57) ABSTRACT

Disclosed below is a system and method for facilitating tracking and tracing plurality of materials. The current disclosure provides a track and trace system and method that enables data gathering and data display at various stages of the supply chain using plurality of labels such as QR Codes and RFIDs present on the products, their packaging, and containers used for their transport. Additionally, various apparatus are used at different levels of the supply chain, at least capturing activity data and querying status of items. The systems and methods thereby enables efficient supply chain management and authenticity of the materials.

### TECHNICAL FIELD

Various embodiments are directed to systems and methods for supply chain management system. More specifically, the present disclosure relates to systems and methods for supply chain management including tracking and tracing, using identifiers such as QR code and RFID on the products and packaging.

### BACKGROUND

Commercial products that are available in retail stores and online shops may contain products that are counterfeited, having safety issues and facing trade disputes. While online purchasing gains market share, consumer cannot predict whether they are buying a genuine product or not. However, producers can increase consumer confidence by building a brand recognition which offers authentication and traceability of their products which is concerned in this embodiment.

Typically, during the supply chain process, various means are used for tracking and tracing. In the medical sector (Companies which transport medicine with packages) they use the combination of QR code and RFID code for traceability at each ownership between trading partners. However entire supply chain data can't be tracked or traced using the said QR Codes and RFIDs using existing systems.

Additionally, a product main package (parent) may contain small packages (child)—Patent-Child (Collective Packaging) and no such solution exists wherein scanning of RFID code on the parent package will provide information of the packages inside the Parent Package. Also, in the case of a package that contain multiple products have a QR code in each product and these batch of QR codes are associated to a RFID in the packaging through a serial number. In the supply chain cycle, some one may tamper with the package and replace the products inside. In the existing solution, this data cant be verified automatically.

In light of the above-mentioned shortcomings associated with existing tracking and tracing systems and methods, it is highly desirable to have a solution that overcomes these technical problems.

### SUMMARY

Embodiments of the present disclosure present technological improvements as solutions to one or more of the above-mentioned technical problems recognized by the inventor in conventional systems.

The present invention discloses a system and method for facilitating tracking and tracing plurality of materials thereby enabling efficient supply chain management. The current disclosure provides a track and trace system and method that enables gathering, manage, analyzing and displaying various data involved throughout a supply chain using plurality of labels present on the products, their packaging, and containers etc. used for their transport. Different application systems are used at different levels of the supply chain, at least capturing activity data and querying status of items.

The labels associated with the materials are associated with a website using a unique URL integrated in the label and the data is stored in a memory device. By triggering label using a label reader, the system updates the status and other data in the memory device and also update the website page associated with the url of the label being scanned and of other labels in an associated relationship with the label being scanned as defined by the set of rules.

In another embodiment of the same invention the system and method is enabled using a distributed ledger based platform such as blockchain. All of the transactions and the data is stored in distributed ledger, this is to ensure a high degree of data confidence. With the tracking ability of RFID, the QR Code provide end consumer the ability to authenticate the product, distributed ledger for data transaction, this process shall provide a trusted solution for the end consumer.

Further, the system and methods disclosed herein has multiple levels of security integrated, which enables access to one or more features of the present invention to the users based on their level of security clearance.

In a primary embodiment, the present invention provides a system for tracking and tracing plurality of materials, the system comprising a hardware processing device communicably coupled via a data communication network with a memory device wherein the hardware processing device, when operated, provides a platform configured to: scan, using a first label reading device, at least one identification label associated with a first material, at least one identification label associated with a second material separate from the first material, wherein the first material and the second material are associated based on a pre-defined set of rules; responsive to the scan using the first label reading device, update the memory device with a first activity data corresponding to the first material, wherein the first activity data corresponding to the first material comprises at least details of the scan using the first label reading device, details of the first material, details of the second material and one or more association parameters between the first material and the second material; a first activity data corresponding to the second material, wherein the first activity data corresponding to the second material comprises at least details of the scan using the first label reading device, details of the first material, details of the second material and the one or more association parameters the first material and the second material; scan, using a second label reading device, the at least one first identification label associated with the first material; responsive to the scan using the second label reading device, update the memory device with a second activity data corresponding to the first material, separate from the first activity data corresponding to the first material, wherein the second activity data corresponding to the first material comprises at least details of the scan using the second label reading device and the first activity data corresponding to the first material and the first activity data corresponding to the second material; and second activity data corresponding to the second material, separate from the first activity data corresponding to the second material, wherein the second activity data corresponding to the second material comprises at least details of the scan using the second label reading device and the first activity data corresponding to the first material and the first activity data corresponding to the second material.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

While the systems and methods are illustrated by use of cell phone embodiments and applications, they are equally applicable to virtually any portable or mobile communication device, including for example, wireless laptop computers and PDAs.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the system for tracking and tracing, in accordance with an embodiment of the present disclosure;

FIG. 2 is an illustration of steps and methods for tracking and tracing, in accordance with an embodiment of the present disclosure.

In the accompanying drawings, an underlined number is employed to represent a material over which the underlined number is positioned or a material to which the underlined number is adjacent. A non-underlined number relates to a material identified by a line linking the non-underlined number to the material. When a number is non-underlined and accompanied by an associated arrow, the nonunderlined number is used to identify a general material at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present invention discloses a system and method for facilitating tracking and tracing plurality of materials thereby enabling efficient supply chain management. The current disclosure provides a track and trace system and method that enables gathering, manage, analyzing and displaying various data involved throughout a supply chain, such as, without limiting the scope of the invention Supplier data, product data, packing data, time stamps, geo location tags, logistic data, activity data and their relations, among others. This is done using plurality of labels present on the products, their packaging, and packages used for their transport. Different application systems are used at different levels of the supply chain, at least capturing activity data and querying status of items.

In various embodiments of the present disclosure, each of the plurality of labels are associated with a separate webpage, the URL of which is detected upon reading each of the plurality of labels. The web page can be customized to display required data. Further, the hardware processor is configured to update the memory device and the web page associated with each of the plurality of labels upon happening of any events, wherein the events are passing through different stages in the supply chain. Additionally, the hardware processor is configured to update the state of one or more materials based on the activity data of an individual label code as well as its family label codes. The hardware processor is further configured to dynamically update and display the status of the plurality of materials.

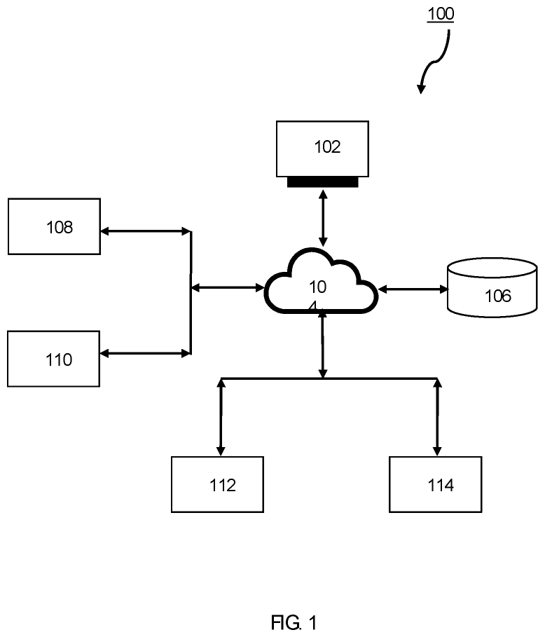

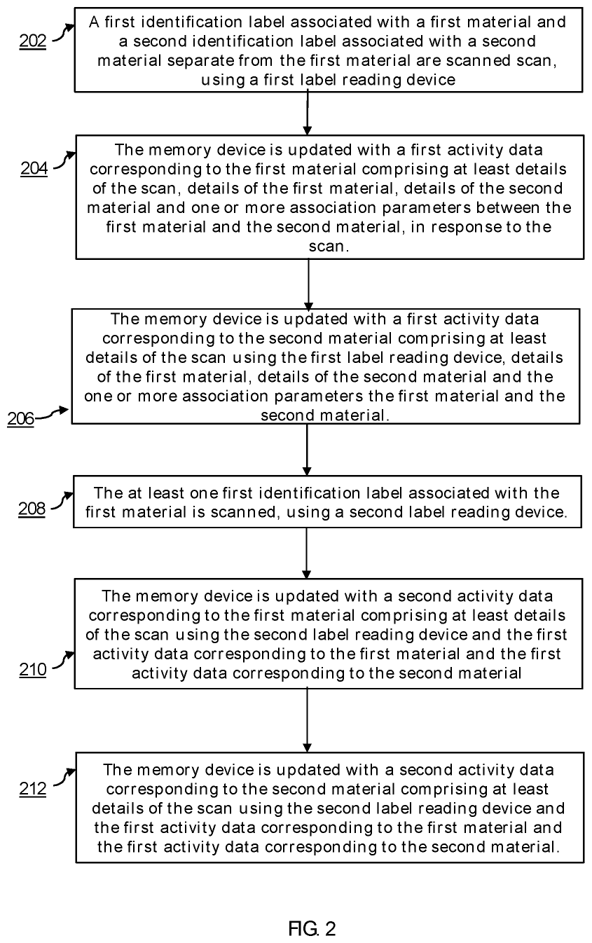

FIG. 1 is a schematic illustration of an exemplary embodiment of the system 100, wherein the system comprises a hardware processor 102 communicably coupled via a communication network 104 with a memory device 106. The hardware processor 102 is further connected to a first label reading device 108, a second label reading device 110, a first user device 112 and a second user device 114.

The primary embodiment of the present invention discloses a system comprising a hardware processing device communicably coupled via a data communication network with a memory device wherein the hardware processing device, when operated, provides a platform configured to track and trace plurality of materials. The hardware processor 102 is configured to enable scanning using the first label reading device 108, at least one identification label associated with a first material, at least one identification label associated with a second material separate from the first material. The said first material and the second material are associated based on a pre-defined set of rules. For illustration purposes only, the first material and the second material may be associated as a parent-child relationship.

Responsive to the scan using the first label reading device 108, the hardware processor 102 is further configured to update the memory device 106 with a first activity data corresponding to the first material, wherein the first activity data corresponding to the first material comprises at least details of the scan using the first label reading device 108, details of the first material, details of the second material and one or more association parameters between the first material and the second material. The hardware processor 102 is further configured to update the memory device 106 with a first activity data corresponding to the second material, wherein the first activity data corresponding to the second material comprises at least details of the scan using the first label reading device 108, details of the first material, details of the second material and the one or more association parameters the first material and the second material.

The hardware processor 102 is additionally configured to enable scanning scan, using a second label reading device 110, the at least one first identification label associated with the first material. In response to the scan using the second label reading device 110, the hardware processor 102 is further configured to update the memory device 106 with a second activity data corresponding to the first material, separate from the first activity data corresponding to the first material, wherein the second activity data corresponding to the first material comprises at least details of the scan using the second label reading device 110 and the first activity data corresponding to the first material and the first activity data corresponding to the second material. The hardware processor 102 is further configured to update the memory device 106 a second activity data corresponding to the second material, separate from the first activity data corresponding to the second material, wherein the second activity data corresponding to the second material comprises at least details of the scan using the second label reading device 110 and the first activity data corresponding to the first material and the first activity data corresponding to the second material.

In another preferred embodiments of the same invention, the hardware processing device 102 is further configured to display using a first user device 112, one or more of the first activity data corresponding to the first material and the first activity data corresponding to the second material, based on a set of access rules, responsive to the scan using the first label reading device 108. The hardware processing device 102 is also configured to display using a second user device 114, one or more of the second activity data corresponding to the first material and the second activity data corresponding to the second material, based on a set of access rules, responsive to the scan using the second label reading device.

One or more components of the invention are described as unit for the understanding of the specification. For example, a unit may include self-contained component in a hardware circuit comprising of logical gate, semiconductor device, integrated circuits or any other discrete component. The unit may also be a part of any software programme executed by any hardware entity for example processor. The implementation of unit as a software programme may include a set of logical instructions to be executed by a processor or any other hardware entity.

Additional or less units can be included without deviating from the novel art of this disclosure. In addition, each unit can include any number and combination of sub-units, and systems, implemented with any combination of hardware and/or software units.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory device (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

Throughout this disclosure the term “user device” refers to devices such as, but not limited to, a mobile phone, tablet, a laptop, a personal computer connected to a widely accessible network such as the Internet, a portable computing device connected to a widely accessible network such as the Internet, any graphical user interface enabling a user to enter an input, a portable communication device, or a personal digital assistant connected to the one or more data communication network. Alternatively, the user deice may be one or more display devices including but not limited to graphical user interface, tv screen, a display monitor, a projector screen. In the following description, the term “user device” refers to any of the communication devices and/or display devices mentioned/not mentioned above or an equivalent.

The one or more data communication network 104 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The one or more data communication network 104 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The one or more data communication network 104 may include any suitable number and type of devices (e.g., routers and switches) for forwarding commands, content, and/or web object requests from each client to the online community application and responses back to the clients. The user device may be compatible with one or more of the following network standards: GSM, CDMA, LTE, IMS, Universal Mobile Telecommunication System (UMTS), RFID, 4G, 5G, 6G and higher.

In one of the embodiments of the same invention, the system enables generation of plurality of uniquely identifiable identification labels based on a predefined set of rules. The term “identification label” here could be defined as uniquely identifiable value used in this invention. The set of rules enable the uniqueness of the labels.

In another embodiment of the present invention, the first label reading device and the second label reading devices are typical label reading devices such as, without limiting the scope, QR Code scanners and RFID readers in the preferred embodiment of the present invention.

In one of the preferred embodiments of the present invention, the at least one identification label associated with a first material and the at least one identification label associated with a second material are QR Codes. In the same embodiment, the first label reading device and the second label reading device are QR Code readers. In an alternate embodiment of the same invention, the at least one identification label associated with a first material and the at least one identification label associated with a second material are RFID Tags. In the same embodiment, the first label reading device and the second label reading device are RFID Tag readers. However, it must be appreciated that the system and method disclosed in the present invention can be achieved by any other types of labels/identifiers and their respective scanners/readers.

In another embodiment of the same invention, a separate url is mapped with each of the plurality of the identification labels such that scanning of each of the plurality of identification labels using the user device results in a url, leading to a web page displaying a customized data comprising at least one or more activity data. The activity data may comprise, without limiting the scope of the invention, as Supplier data, product data, packing data, time stamps, geo location tags, logistic data and their relations. The web page is customizable to display required data in a required format. Additionally, the web page may vary based on security level clearance of a user associated with the user device. Thus, based on the user's security clearance, content displayed on the user device may vary.

In one of the embodiment of the present invention, the label associated with the first material is present on the first material and the label associated with the second material is present on the second material. Alternatively, the label associated with the first material and the label associated with the second material are embedded on the first material and the second material respectively.

In another aspect of the present disclosure, depending on the plurality of the materials and the context of use of the present system and method, different types of labels are used in different levels and the relationship between the labels indicate the relationship between the materials. As an illustration, the first material may be multiple bottles to be transported and the second material may be the crate in which they are transported. A first label is present in each of the bottle and a second label is present on the crate in which the bottles are packed. The relationship between the first material and the second material is that of package and product and also, all the bottles present in the crate are associated with the single second label present on the crate, indicating a child-parent relationship between the two.

At the system level, for example, a friendly and commonly applicable usage is the QR code as a label. The content of a QR code is a URL that takes the label reading device directly to a webpage wherein customized activity data is displayed. This means instead of having serial number for the QR code, this embodiment uses a URL which is unique to that label only. In this invention, each QR code (thus each URL) must be uniquely bound to a particular unit of a material such that the trace would be resolved to that particular unit of the material, as far as that particular user is concerned. The activity data displayed in the webpage may vary depending on stage of the supply chain the particular material is in and also the security clearance of the user. For example, at the end point, the system can present to the user, entire transaction history. At another stage in the supply chain, a different information is displayed. Other examples are shipment records during shipping and addition of marketing and customer services information during the aftersales state. Alternatively, any other types of labels may be used such as RFID tags, and others.

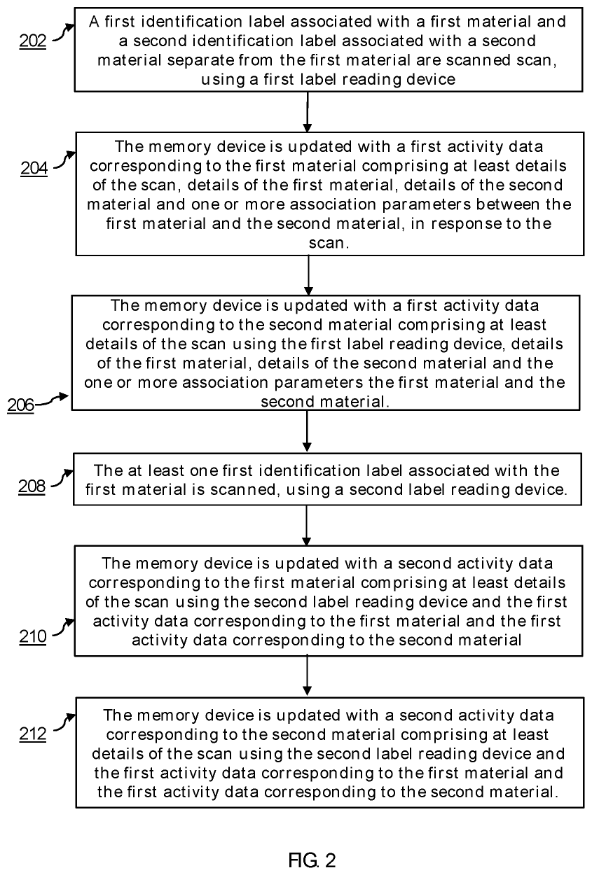

FIG. 2 depicts a preferred embodiment of a method for tracking and tracing of materials. The method comprises method steps being executed by a hardware processor 102 communicably coupled via a communication network 104 with a memory device 106, a first label reading device 108, a second label reading device 110, a first user device 112 and a second user device 114. The method being executed by a non-transitory computer readable medium including program code wherein upon execution the program code executes in an environment of computer systems providing method for housekeeping supplies and equipment management.

At a step 202, a first identification label associated with a first material and a second identification label associated with a second material separate from the first material are scanned scan, using a first label reading device. At a step 204, in response to the scan, the memory device is updated with a first activity data corresponding to the first material comprising at least details of the scan, details of the first material, details of the second material and one or more association parameters between the first material and the second material. At a step 206, the memory device is updated with a first activity data corresponding to the second material comprising at least details of the scan using the first label reading device, details of the first material, details of the second material and the one or more association parameters the first material and the second material. At a step 208, the at least one first identification label associated with the first material is scanned, using a second label reading device. At a step 210, the memory device is updated with a second activity data corresponding to the first material comprising at least details of the scan using the second label reading device and the first activity data corresponding to the first material and the first activity data corresponding to the second material. At a Step 212, the memory device is updated with a second activity data corresponding to the second material comprising at least details of the scan using the second label reading device and the first activity data corresponding to the first material and the first activity data corresponding to the second material.

In another embodiment of the same invention, the system and methods disclosed herein has multiple levels of security levels integrated for the users, based on which the content being displayed on the user device varies. Further, each user has a separate security clearance and a set of predefined rules associated with each security clearance. Additionally, the hardware processor is configured to restrict the access to the system for each user based on the said security clearance for each user and the set of predefined rules associated with each security clearance. For illustrative purpose only, a transport/logistic person may only be able to see data regarding delivery of the materials such as delivery address but not other data such as manufacture data, packaging data, etc. The security level of each user and the security clearance of each user is identified using a unique user id associated with the user. This is done while the user is logging on to the system using the user device.

In various embodiments of the present invention, the labels associated with each materials can further joined/interlinked by defining associative relationship of the materials and physical relationship of them. If a certain number of units of product items that are shipped within a unit of carton, each unit of the product has a unique label applied, and the carton has a separate label applied, wherein the relationship between the carton and the products are defined and it indicates the specific units of products present inside the carton. The label of the carton is the Parent of the labels of the units of products within. Any logistic transaction of the carton recorded in the track and trace system automatically updates the information related to the units of products present inside the carton as well. At any checkpoint in the supply chain cycle, if a certain product is removed and its label scanned, it automatically updates the data associated with the label on the carton as well. Thereby, if a user scans the label of the carton, they would be able to know when and what unit of product was taken out of the carton. Further, at the end-consumer point, upon purchase or receive of a unit of the product item, it can be backtrack the specific carton through the label on the unit of the item and the relationship recorded in the system.

Alternatively, optionally, using the above systems and methods, any number of materials at any level can be linked with another material at another level to build a family tree or a map of material relationship, stored in the memory device. Additional applications may be built on top of the track and trace system.

Unique labels and its Unique URLs are associated with labels at all levels and the labels are associated with items at all levels. Multiple labels and codes can be applied on an item to facilitate different checkpoint scenarios using different readers such as using a RFID reader for mass no-line-of-sight scanning in a logistic checkpoint and using a consumer level mobile device for scanning in end-consumer level authenticity check.

At a certain checkpoint, (for example a logistic checkpoint) human operator with label reading device including but not limited to automated scanning apparatus read the plurality of labels and update the memory device with data including a new status and time stamp information associated with each of the plurality labels and their associated labels based on their relationship and set of rules stored in the memory device. The same is also updated on the webpage associated with the URL which is there associated with the label. In operation of the system, upon scanning of the materials at any stage of the supply chain, the track and trace system is updated with a new status and time stamp which may change the content to be display for the URL or in other words the content of the webpage. For example, shipping together with a time stamp and location is additional information for the shipper which is shown as a content of the webpage as relevant to the shipper.

For illustrative purposes only, without limiting the scope of the invention, in one of the embodiments, consider a use case at a first check point ‘A’, label reading device ‘A’ will scan a label to identify the URL which is affiliated with the label. (For example, the product get scanned when shipping out from factory). Upon scanning, the system is updated with the activity data and the same is associated with the label and other labels that are linked with the particular label. At a checkpoint ‘B’, the label is scanned again using label reading device ‘B’. Upon scanning, the system is updated with new activity data and the same is associated with the label and other labels that are linked with the particular label. The Content of the webpage will change according to the stage in the supply chain. Further it is explained here that the content will be shown according to the authorization given to each user and the status of the materials. The webpage content or the details in the webpage will be dynamically updated using the hardware processor in response to scanning the labels, wherein the website is identified using the URL associated with the label.

In another aspect, the content on the website will change from user to user according to the security clearance, identified via user authentication. As an illustration, a shipper can see the details related to shipping and a customer can view the information he/she needs and the information or the content that is relevant to them such as product information, upon scanning the label associated with the material. This process takes place according to the authorization is given to the relevant user. As an example, without limiting the scope of the invention, a user with credential “Shipper” may scan the URL and sees the Logistic Information. When a consumer scans the label upon purchase the product, the website may display an authentication message and marketing message. Additionally, when the consumer scans the label after a predefined period or an expiry period, a message may be displayed to warn the consumer to not use the product since the last use date has expired and it is not safe to use.

In another embodiment of the same invention, the system and methods enable the hardware processor to authenticate and validate the unique labels if necessary. Upon scanning, if a previous transaction record found, the new record is associated with the old record in a way that a chain of transaction record history of a certain code could be built.

The systems and methods may be implemented to achieve the same result using mobile devices and a mobile page instead of website. The camera of the mobile device may be used to read the labels. Alternatively, optionally, the system and method may be used to generate a report to the user which helps in training and analysis and improve the supply chain.

Further in another embodiment, the production and or packaging, label or multiple labels may be applied to the product and/or packaging. In operation, these labels will be updated with the system and the memory device stores the relationships between the labels. Each label provides a URL which leads to the web page when the QR Code is scanned. A scan of the label on outside package/container will update everything inside the container without scanning any of the labels inside the container. Further, for example, 20 pallets arrived at a destination are to be distributed to several dealers. Dealer A tows x number of pallets within the container after scanning labels present on each of the x number of pallets. This also updates the data associated with the label on the container indicating the removal of the said x number of pallets.

In an alternative embodiment of the same invention, the said invention is built using a distributed ledger based platform such as blockchain wherein the rule set, activity data and other data are stored on the blockchain as blocks. Any new data based on a new activity is added onto the blockchain as a new block. Additional aspects of the system and methods use smart contracts for execution. Another aspect of the disclosure is the use of one or more cryptocurrencies within the system. Use of blockchain increases the trust of the users since the data is authentic and cant be modified.

Beneficially, some of the embodiments of the present technical solution may also be modified to provide benefits including but not limited to (a) during shipment, materials are usually handled by logistic agents at logistic check points. Using of labels that allow massive no-eye-of-sight batch processing is more suitable on site. Using RFID tags and/or QR Codes carrying a unique code associated with a particular material being shipped (e.g. pallets and cartons) allows the track and trace system to process records in large batches. (b) providing more informative historic records, data analysis for improvements, brand building, consumer confidence enhancement, safety tracking, etc. (c) It can provide a feedback loops for the users and help in digitizing trade (d) ensures traceability and authenticity of the products.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for materials, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions. It will be appreciated that features of the present disclosure are susceptible to being combined in various combinations and additional features may be introduced without departing from the scope of the present disclosure.

1. A system for tracking and tracing plurality of materials, the system comprising a hardware processing device communicably coupled via a data communication network with a memory device wherein the hardware processing device, when operated, provides a platform configured to:
scan, using a first label reading device, at least one first identification label associated with a first material, at least one second identification label associated with a second material separate from the first material, wherein the first material and the second material are associated based on a pre-defined set of rules;
responsive to the scan using the first label reading device, update the memory device with
a first activity data corresponding to the first material, wherein the first activity data corresponding to the first material comprises at least details of the scan using the first label reading device, details of the first material, details of the second material and one or more association parameters between the first material and the second material;
a first activity data corresponding to the second material, wherein the first activity data corresponding to the second material comprises at least details of the scan using the first label reading device, details of the first material, details of the second material and the one or more association parameters the first material and the second material;
scan, using a second label reading device, the at least one first identification label associated with the first material;
responsive to the scan using the second label reading device, update the memory device with a
second activity data corresponding to the first material, separate from the first activity data corresponding to the first material, wherein the second activity data corresponding to the first material comprises at least details of the scan using the second label reading device and the first activity data corresponding to the first material and the first activity data corresponding to the second material; and
second activity data corresponding to the second material, separate from the first activity data corresponding to the second material, wherein the second activity data corresponding to the second material comprises at least details of the scan using the second label reading device and the first activity data corresponding to the first material and the first activity data corresponding to the second material.

2. The system of claim 1 wherein the hardware processing device is further configured to display using a user device, one or more of the first activity data corresponding to the first material and the first activity data corresponding to the second material, based on a set of access rules, responsive to the scan using the first label reading device.

3. The system of claim 1 wherein the hardware processing device is further configured to display using the user device, one or more of the second activity data corresponding to the first material and the second activity data corresponding to the second material, based on a set of access rules, responsive to the scan using the second label reading device.

4. The system of claim 1 wherein
the at least one first identification label associated with a first material the at least one second identification label associated with a second material are QR Codes; and
the second label reading device and second label reading device are QR Code readers.

5. The system of claim 1 wherein
the at least one first identification label associated with a first material the at least one second identification label associated with a second material are RFID Tags; and
the second label reading device and second label reading device are RFID Tag readers.

6. The system of claim 1 wherein the scanning of each of the identification labels using the user device results in a URL, leading to a page displaying a customized data comprising at least one or more activity data.

7. The system of claim 1 wherein, the user device is a mobile phone.

8. The system of claim 1 wherein the at least one first identification label associated with the first material is present on the first material and the at least one second identification label associated with the second material is present on the second material.

9. The system of claim 1 wherein the first material is an outer package and the second material is a unit product present within the first material.

10. The system of claim 1 wherein the hardware processing device is communicably coupled via the data communication network to one or more of a centralized ledger based platform, a distributed ledger based platform and each of the activity data is stored on the one or more of the centralized ledger based platform, the distributed ledger based platform.

11. A method for tracking and tracing plurality of materials, the method comprising a hardware processing device communicably coupled via a data communication network with a memory device:
scanning, using a first label reading device, at least one first identification label associated with a first material, at least one second identification label associated with a second material separate from the first material, wherein the first material and the second material are associated based on a pre-defined set of rules;
responsive to the scan using the first label reading device, updating the memory device with
a first activity data corresponding to the first material, wherein the first activity data corresponding to the first material comprises at least details of the scan using the first label reading device, details of the first material, details of the second material and one or more association parameters between the first material and the second material;
a first activity data corresponding to the second material, wherein the first activity data corresponding to the second material comprises at least details of the scan using the first label reading device, details of the first material, details of the second material and the one or more association parameters the first material and the second material;
scanning, using a second label reading device, the at least one first identification label associated with the first material;
responsive to the scan using the second label reading device, updating the memory device with a
second activity data corresponding to the first material, separate from the first activity data corresponding to the first material, wherein the second activity data corresponding to the first material comprises at least details of the scan using the second label reading device and the first activity data corresponding to the first material and the first activity data corresponding to the second material; and
second activity data corresponding to the second material, separate from the first activity data corresponding to the second material, wherein the second activity data corresponding to the second material comprises at least details of the scan using the second label reading device and the first activity data corresponding to the first material and the first activity data corresponding to the second material.

12. The method of claim 11 wherein responsive to the scan using the first label reading device, displaying using a user device, one or more of the first activity data corresponding to the first material and the first activity data corresponding to the second material, based on a set of access rules.

13. The method of claim 11 wherein responsive to the scan using the first label reading device, displaying using the user device, one or more of the second activity data corresponding to the first material and the second activity data corresponding to the second material, based on a set of access rules.

14. The method of claim 11 wherein
the at least one first identification label associated with a first material the at least one second identification label associated with a second material are QR Codes; and
the second label reading device and second label reading device are QR Code readers.

15. The method of claim 11 wherein
the at least one first identification label associated with a first material the at least one second identification label associated with a second material are RFID Tags; and
the second label reading device and second label reading device are RFID Tag readers.

16. The method of claim 11 wherein the scanning of each of the identification labels using the user device results in a URL, leading to a page displaying a customized data comprising at least one or more activity.

17. The method of claim 11 wherein, the user device is a mobile phone.

18. The method of claim 11 wherein the at least one first identification label associated with the first material is present on the first material and the at least one second identification label associated with the second material is present on the second material.

19. The method of claim 11 wherein the first material is an outer package and the second material is a unit product present within the first material.

20. The method of claim 11 wherein the hardware processing device is communicably coupled via the data communication network to one or more of a centralized ledger based platform, a distributed ledger based platform and each of the activity data is stored on the one or more of the centralized ledger based platform, the distributed ledger based platform.
